(19) United States
(12) Patent Application Publication
(10) Pub. No.: US 2025/0335155 A1
(43) Pub. Date: Oct. 30, 2025

(54) DILITHIUM MODULAR REDUCTION ARCHITECTURE

(71) Applicant: Microsoft Technology Licensing, LLC, Redmond, WA (US)

(72) Inventors: Mojtaba BISHEH NIASAR, Dover, NH (US); Naga Kiranmayee Upadhyayula, Redmond, WA (US); Bharat S. Pillilli, EI Dorado Hills, CA (US)

(21) Appl. No.: 18/647,426

(22) Filed: Apr. 26, 2024

(51) Int. Cl. G06F 7/523

(52) U.S. Cl. CPC G06F 7/523

(57) ABSTRACT

Devices, systems, and methods for modular multiplication are provided. A circuit for modular multiplication can include a single multiplier configured to receive two variables and produce a product of the two variables, first adders configured to receive one or more subsets of contiguous bits of the product and generate sums based on received subsets of contiguous bits, second adders configured to receive at least a portion of the sums from the first adders and generate intermediate sums, a customized adder configured to receive another, different subset of contiguous bits of the product and an intermediate sum of the intermediate sums and generate a sum based on the received subset of contiguous bits and the intermediate sum, and a subtractor configured to receive the sum from the customized adder and another intermediate result of the intermediate results and generate a result that is the product modulo a prime number, q=8,380,417.

### BACKGROUND

The advent of quantum computers poses a serious challenge to the security of the existing public-key cryptosystems, as they can be potentially broken based on Shor's algorithm. Lattice-based cryptosystems are among the most promising post-quantum cryptography (PQC) algorithms that are believed to be hard for both classical and quantum computers to break.

Number Theoretic Transform (NTT) and Inverse Number Theoretic Transform (INTT) can be used in a lattice-based PQC algorithm to reduce the computation cost of computing a polynomial multiplication. Modular multiplication is typically used in an NTT/INTT architecture.

### SUMMARY

A method, device, system, or a machine-readable medium for number theoretic transform (NTT) and inverse NTT (INTT) are provided. A circuit can perform modular multiplication with just a single, non-modular multiplier. A modular multiplication circuit can include a single multiplier configured to receive two variables and produce a product of the two variables. The circuit can include first adders configured to receive one or more subsets of contiguous bits of the product and generate sums based on received subsets of contiguous bits. The circuit can include second adders configured to receive at least a portion of the sums from the first adders and generate intermediate sums. The circuit can include a customized adder configured to receive another, different subset of contiguous bits of the product and an intermediate sum of the intermediate sums and generate a sum based on the received subset of contiguous bits and the intermediate sum. The circuit can include a subtractor configured to receive the sum from the customized adder and another intermediate result of the intermediate results and generate a result that is the product modulo a prime number, q=8,380,417.

The circuit can include a first register situated between the single multiplier and the first adders. The first adders can be non-modular adders. The second adders can include a modular adder and a non-modular adder. The customized adder can be a modular adder. The subtractor can be a modular subtractor.

The first adders can include a first adder configured to receive, as input, four non-overlapping subsets of contiguous bits of the product and generate a sum based on the input. The first adders can further include a second adder configured to receive, as input, two overlapping subsets of contiguous bits of the product and generate a sum based on the input.

The second adders can include a third adder configured to receive, as input, non-overlapping subsets of contiguous bits of the sum from the first adder and generate a sum based on the input. The second adders can further include a fourth adder configured to receive, as input, (i) the sum from the second adder and (ii) a subset of contiguous bits of the product and generate a sum based on the input, the sum a first intermediate result of the intermediate results.

The customized adder can include a shifter configured to shift the sum from the third adder a specified number of bits resulting in a shifted sum, and a fifth adder configured to receive, as input, (i) the shifted sum and (ii) a subset of contiguous bits of the product and generate a sum based on the input, the sum a second intermediate result of the intermediate results.

A device, machine-readable medium, system, or method can be configured to implement the functionality of or include the circuit.

### BRIEF DESCRIPTION OF DRAWINGS

FIG. 1 illustrates, by way of example, a conceptual circuit diagram of an embodiment of a CT butterfly operator circuit.

FIG. 2 illustrates, by way of example, a conceptual circuit diagram of an embodiment of a GS butterfly operator circuit.

FIG. 3 illustrates, by way of example, a diagram of an embodiment of a circuit for performing modular addition and subtraction.

FIG. 4 illustrates, by way of example, a diagram of an embodiment of a circuit for performing modular addition for Dilithium.

FIG. 5 illustrates, by way of example, a diagram of an embodiment of a circuit for modular multiplication in Dilithium cryptography operations.

FIG. 6 illustrates, by way of example, a block diagram of an embodiment of a method for modular multiplication operations.

FIG. 7 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Cloud computing has become an integral part of modern society, offering various services and applications to individuals and organizations. The security of cloud computing is threatened by the advent of quantum computers, which can potentially break the existing public-key cryptosystems, such as Rivest-Shamir-Adleman (RSA) and Elliptic Curve Cryptography (ECC) based on Shor's algorithm. Shor's algorithm is a quantum computer algorithm for finding the prime factors of an integer. Current public-key cryptography is not presently threatened by modern quantum computers. However, cloud resource managers should anticipate the challenge quantum computers pose to modern cryptography and initiate a transition to a postquantum era in a timely manner. In fact, the U.S. government issued a National Security Memorandum in May 2022 that mandated federal agencies to migrate to post-quantum cryptosystems (PQC) by 2035 to mitigate risks to vulnerable cryptographic systems.

A long-term security of cloud computing against quantum attacks can benefit from developing lattice-based cryptosystems, which are among the most promising PQC algorithms that are believed to be hard for both classical and quantum computers. NTT and INTT can be used to achieve more efficient polynomial multiplication in lattice-based cryptosystems. NTT and INTT help reduce algorithm complexity from O (n²) to O (n log n). The complexity of the NTT and INTT computation can benefit from improvement in terms of efficiency so as to help improve operation of the lattice-based cryptosystems.

Circuit architectures described herein reduce the complexity of computing the NTT and INTT in, for example, a Dilithium PQC algorithm. The circuit is a hardware-friendly modular reduction algorithm with respect to Dilithium prime q (=8,380,417). The circuit includes no additional multiplications by leveraging the prime value of q=8,380,417. The circuit architectures are highly efficient and constant-time and addresses the efficiency and performance challenges in designing lattice-based cryptosystems.

NTT and INTT operations can be accomplished iteratively. NTT and INTT can be performed by applying a sequence of “butterfly operations” on the input polynomial coefficients. Butterfly operations are arithmetic operations that combine two coefficients of polynomials to obtain two outputs. The NTT and INTT operations can be computed in a logarithmic number of steps using repeated butterfly operations.

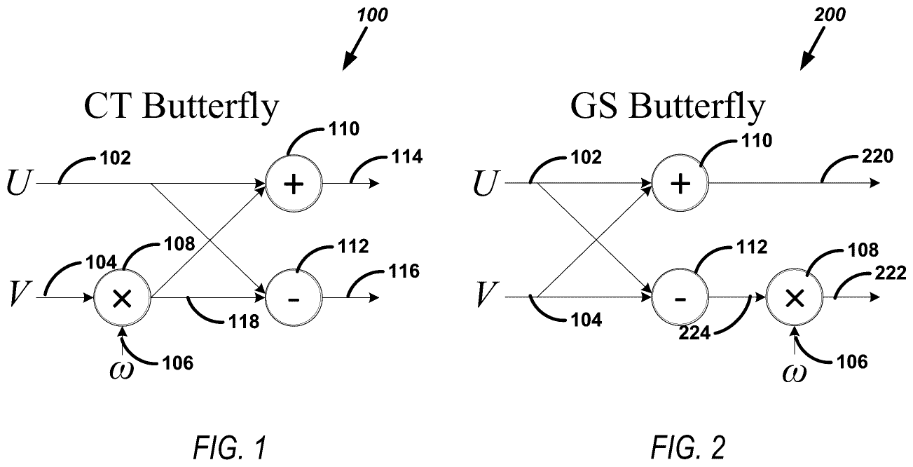

In embodiments, Cooley-Tukey (CT) and Gentleman-Sande (GS) butterfly configurations can be used to facilitate NTT/INTT computation. A commonly required bit-reverse function reverses the bits of the coefficient index. However, the bit-reverse permutation can be skipped by using CT butterfly operations for NTT and GS butterfly operations for INTT. FIGS. 1 and 2 illustrate a CT butterfly operator and the GS butterfly operator, respectively. All operations of the CT and GS butterfly operators 100 and 200 are modular operations. More details regarding NTT/INTT and lattice-based computation of NTT/INTT are provided elsewhere herein.

FIG. 1 illustrates, by way of example, a conceptual circuit diagram of an embodiment of a CT butterfly operator circuit 100. The circuit 100 performs the CT butterfly operations. The circuit 100 takes, as input U 102 and V 104, which are coefficients of respective polynomials, and ω 106, which is a weight. V 104 and ω 106 are modular multiplied ((V*ω) mod q) using a multiplier 108. A result 118 of the multiplication performed by the multiplier 108 and U 102 are added using an modular adder 110 to generate a first output coefficient 114. The result 118 and U 102 are subtracted using a modular subtractor 112 to generate a second output coefficient 116. The first and second output coefficients 114 and 116 can then be used as inputs, U and V, respectively, in a next iteration of circuit 100 operation.

Pseudocode for an iterative NTT operation using the CT butterfly operator circuit 100 is provided:

In-Place NTT Algorithm using CT Butterfly Operator Circuit

| Require: a(x) ∈ R_{q}, ωₙ ∈ [symbol] , n = 2^{l} | |
|---|---|
| Ensure: â(x) = NTT (a) ∈ R_{q} | |
| 1: | â ← bit − reverse(a) |
| 2: | for i from 1 to l do |
| 3: | m = 2^{l-i} |
| 4: | for j from 0 to 2ⁱ⁻¹ − 1 do |
| 5: | $W ← {ω}_{n}^{1 + j}$ |
| 6: | for k from 0 to m − 1 do |
| 7: | U ← â[2jm + k] |
| 8: | V ← â[2jm + k + m] mod q |
| 9: | T ← V · W |
| 10: | â[2jm + k] = U + T mod q |
| 11: | â[2jm + k + m] = U − T mod q |
| 12: | end for |
| 13: | end for |
| 14: | end for |
| 15: | return â(x) ∈ R_{q} |

where a is a polynomial and ω is a twiddle factor, and n is a number of coefficients in the polynomial.

FIG. 2 illustrates, by way of example, a conceptual circuit diagram of an embodiment of a GS butterfly operator circuit 200. The circuit 200 performs the mathematical operations the GS butterfly operation. The circuit 200 takes, as input U 102, V 104, and ω 106. U and V are added mod q, by modular adder 110, resulting in a first output coefficient 220. U 102 and V 104 are subtracted mod q, by modular subtractor 112, resulting in result 224. The result 224 is then multiplied by a weight, ω 106, using a modular multiplier 108. A result of the multiplication performed by the multiplier 108 is a second output coefficient 222. The first and second output coefficients 220 and 222 can then be used as inputs in a next iteration of circuit 200 operation.

What follows is a description of NTT/INTT. Let q be a prime number and [symbol] be the ring of integers modulo q. Define the ring of polynomials for some integer N as R_{q}= [symbol] [X]/(X^{N}+1), where the polynomials have n coefficients, each modulo q. Regular font lowercase letters (a) represent single polynomials, bold lowercase letters (a) represent polynomial vectors, and bold uppercase letters (A) to represent a matrix of polynomials. Representations in the NTT domain are represented by (â), (â) and (Â), respectively. Let a and b be polynomial vectors in R_{q}. Let a∘b∈R_{q} denote coefficient-wise multiplication of polynomials. The○product of a matrix and a vector is the natural extension of coefficient-wise multiplication of the polynomial vectors.

A naive method of polynomial multiplication has O (n²) complexity. This complexity can be reduced by using NTT. To multiply two polynomials efficiently in lattice-based cryptography, the polynomial rings of the form R_{q}= [symbol] [X]/(X^{N}+1) can be used, where (X^{N}+1) enables fast polynomial division. The NTT transform maps polynomials to the NTT domain at the cost of O (n*logn) where multiplying their coefficients results in a polynomial that corresponds to the product of the original polynomials modulo q and (X^{N}+1). Coefficient-wise multiplication has a complexity of O(n). A total time complexity is thus O (n·log n).

The NTT is a generalization of a fast Fourier transform (FFT) defined in a finite field. Suppose f is a polynomial of degree n with coefficients in [symbol] , as:

$$f = {\sum }_{i = 0}^{n - 1} {f}_{i} {X}^{i}$$

FFT uses the twiddle factor ωₙ n-th root of unity of form e^{2πj/n}, while NTT has ωₙ∈ [symbol] such that ωₙ be a primitive n-th root of unity modulo q, i.e. ωₙⁿ=1 mod q. The NTT transforms f, i.e., \hat{f}=NTT(f), is computed as follows for each i∈{0,1, . . . , n-1}:

$$\hat{{f}_{i}} = {\sum }_{j = 0}^{n - 1} {f}_{j} {ω}_{n}^{ij}$$

The INTT recovers f from \hat{f} as:

$${f}_{i} = {\sum }_{j = 0}^{n - 1} \hat{{f}_{j}} {ω}_{n}^{- ij}$$

Hence, the multiplication between two polynomials f and g using NTT can be performed as:

$$f \cdot g = lNTT ( NTT ( f ) ◦ NTT ( g ) )$$

NTT algorithm is shown in pseudocode elsewhere herein.

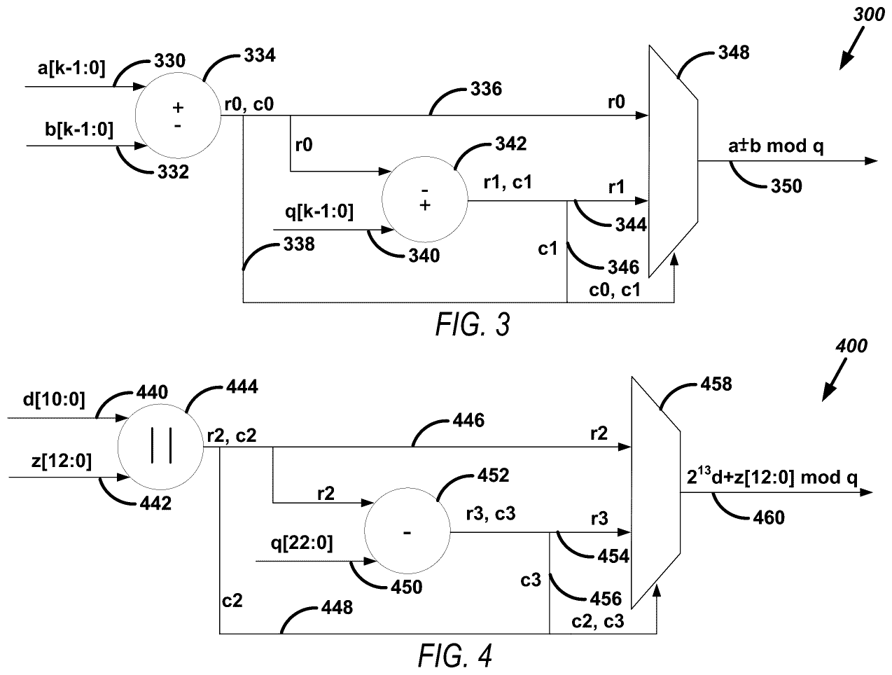

The modular addition and modular subtraction of the CT and GS butterfly operator circuits of FIGS. 1 and 2 can be implemented using two, non-modular adders and subtractors. Such a configuration is illustrated in FIG. 3.

FIG. 3 illustrates, by way of example, a diagram of an embodiment of a circuit 300 for performing modular addition and subtraction. The circuit 300 as illustrated includes non-modular adder/subtractor 334, non-modular subtractor/adder 342, and a multiplexer 348. The circuit 300 generates an output 350 that is a modular addition/subtraction of variables a 330 and b 332 modular a prime number, q.

The adder/subtractor 334 adds a 330 and b 332 when in adder mode and subtracts a 330 and b 332 when in subtractor mode. The adder/subtractor 334 is in adder mode when performing modular addition (e.g., for modular adder 110 see FIGS. 1 and 2) and in subtractor mode when performing modular subtraction (e.g., for modular subtractor 112 see FIGS. 1 and 2). The adder/subtractor 334 generates a sum 336 and a carry 338.

The subtractor/adder 342 subtracts the sum, r0, 336 and q 340 when in subtractor mode and adds the sum 336 and q 340 when in subtractor mode. The subtractor/adder 342 is in subtractor mode when performing modular addition (e.g., for modular adder 110 see FIGS. 1 and 2) and in adder mode when performing modular subtraction (e.g., for modular subtractor 112 see FIGS. 1 and 2). The subtractor/adder 342 generates a sum 344 and a carry 346.

The multiplexer 348 selects which of the sums 336, 344 is the correct output 350 based on the carry 338 and carry 346. In addition mode, r1 344 is chosen when c0 XOR c1 is 1, otherwise r0 336 is provided. In subtraction mode, if c0 338 is set (equal to “1”) r0 336 336 is provided, otherwise r1 344 is provided.

The circuit 300 of FIG. 3 performs modular addition and/or subtraction using non-modular components. Modular multiplication, the multiplier 108 of FIGS. 1 and 2, can be implemented using different techniques. The commonly used Barrett reduction and Montgomery reduction techniques require more than one multiplier and are suitable for a non-specific modulus. Further, Montgomery reduction needs two more steps to convert all inputs from normal domain to Montgomery domain and then convert back the results into normal domain. These operations converting between domains increases the latency of NTT operations and causes delay in performance. Hence, Barrett reduction and Montgomery reduction are expensive in terms of time and hardware resources.

An improved Dilithium hardware accelerator includes a reduction architecture that is customized based on the prime value of q=8,380,417 to increase the efficiency of computation. The value of q can be presented by:

$$q = 8 , 380 , 417 = {2}^{23} - {2}^{13} + 1$$

For the modular operation:

$${2}^{23} = {2}^{13} - 1 mod q$$

Suppose that all input operands are less than q, then:

$$0 \leq a , b < q$$

$$z = a \cdot b < {q}^{2} = {46}^{′} h 3 FE0\_ 04 FF\_C001$$

Based on 2²³=2¹³−1 mod q, one can rewrite the equation as follows:

$$z = {2}^{23} z [ 45 : 23 ] + z [ 22 : 0 ] = {2}^{13} z [ 45 : 23 ] - z [ 45 : 23 ] + z [ 22 : 0 ] = {2}^{23} z [ 45 : 33 ] + {2}^{13} z [ 32 : 23 ] - z [ 45 : 23 ] + z [ 22 : 0 ] = {2}^{13} z [ 45 : 33 ] - z [ 45 : 33 ] + {2}^{13} z [ 32 : 23 ] - z [ 45 : 23 ] + z [ 22 : 0 ] = {2}^{23} z [ 45 : 43 ] + {2}^{13} z [ 42 : 33 ] - z [ 45 : 33 ] + {2}^{13} z [ 32 : 23 ] - z [ 45 : 23 ] + z [ 22 : 0 ] = {2}^{13} z [ 45 : 43 ] - z [ 45 : 43 ] + {2}^{13} z [ 42 : 33 ] - z [ 45 : 33 ] + {2}^{13} z [ 32 : 23 ] - z [ 45 : 23 ] + z [ 22 : 0 ] = {2}^{13} ( z [ 45 : 43 ] + z [ 42 : 33 ] + z [ 32 : 23 ] ) + ( - z [ 45 : 43 ] - z [ 45 : 33 ] - z [ 45 : 23 ] + z [ 22 : 0 ] ) = {2}^{13} ( z [ 45 : 43 ] + z [ 42 : 33 ] + z [ 32 : 23 ] + z [ 22 : 13 ] ) + ( - z [ 45 : 43 ] - z [ 45 : 33 ] - z [ 45 : 23 ] + z [ 12 : 0 ] ) = {2}^{13} c - ( z [ 45 : 43 ] + z [ 45 : 33 ] + z [ 45 : 23 ] ) + z [ 12 : 0 ]$$

Where:

$$c = z [ 45 : 43 ] + z [ 42 : 33 ] + z [ 32 : 23 ] + z [ 22 : 13 ] < {2}^{12}$$

The value of c has 12 bits, and can be represented as follows:

$${2}^{13} c [ 11 : 0 ] = {2}^{23} c [ 11 : 10 ] + {2}^{13} c [ 9 : 0 ] = {2}^{13} c [ 11 : 10 ] - c [ 11 : 10 ] + {2}^{13} c [ 9 : 0 ] = {2}^{13} d - c [ 11 : 10 ]$$

$$d = c [ 11 : 10 ] + c [ 9 : 0 ]$$

So, the value of z mod q is as follows:

$$z = {2}^{13} c - ( z [ 45 : 43 ] + z [ 45 : 33 ] + z [ 45 : 23 ] ) + z [ 12 : 0 ] = {2}^{13} d + z [ 12 : 0 ] - ( ( z [ 45 : 43 ] + z [ 45 : 33 ] + z [ 45 : 23 ] ) + c [ 11 : 10 ] ) = {2}^{13} d + z [ 12 : 0 ] - e$$

Where:

$$e = ( z [ 45 : 43 ] + z [ 45 : 33 ] + z [ 45 : 23 ] ) + c [ 11 : 10 ] = f + z [ 45 : 23 ] mod q$$

$$f [ 14 : 0 ] = z [ 45 : 43 ] + z [ 45 : 33 ] + c [ 11 : 10 ]$$

When using a modular addition for f+z[45:23] to keep it less than q. This modular addition has one stage delay.

The addition between 2¹³ d and z [12:0] can be implemented by concatenating since the first 13 bits of d are zero as follows:

$$g [ 23 : 0 ] = {2}^{13} d + z [ 12 : 0 ] = d [ 10 : 0 ] ‖ z [ 12 : 0 ]$$

Since the result has more than 23 bits, a modular addition can be performed to keep it less than q. For the modular addition, the regular modular addition can be replaced by the following architecture while c2=g[23], r2=g[22:0]. In other words, c2=d[10], r2[22:0]=d[9:0]∥z [12:0]

FIG. 4 illustrates, by way of example, a diagram of an embodiment of a circuit 400 for performing modular addition for Dilithium. The circuit 400 can be used in place of the circuit 300 when performing cryptography using a Dilithium algorithm. The circuit 400 as illustrated includes a shift and concatenate operator 444, non-modular subtractor 452, and a multiplexer 458. The circuit 400 generates an output 460 that is a modular addition of a specified number of bits of variables d 440 and z 442 modulo the prime number, q 450.

The shift and concatenate operator 444 shifts d 440 to the left thirteen bits (to be a bigger number with thirteen trailing zeros) to generate a left-shifted result. The shift and concatenate operator 444 concatenates the left-shifted result and the least significant thirteen bits of z 442 to generate a result 446 and a carry 448. The subtractor 452 subtracts the sum 446 and q 450. The subtractor 452 generates a result 454 and a carry 456.

The multiplexer 458 selects which of the results 446, 454 is the correct output 460 based on the carry 448 and carry 456. If c2 XOR c3 is 1, then r3 454 is provided, otherwise r2 446 is provided.

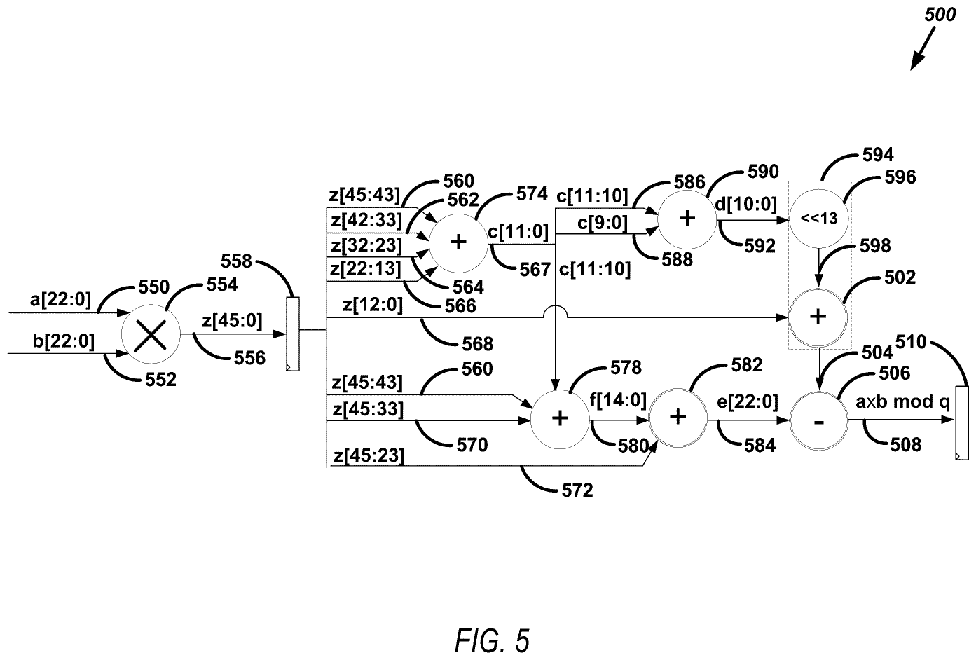

Using the circuit 400 allows one to perform a modular multiplication using a single multiplier and while performing cryptography using Dilithium. Such a modular multiplier is illustrated in FIG. 5.

FIG. 5 illustrates, by way of example, a diagram of an embodiment of a circuit 500 for modular multiplication in Dilithium cryptography operations. The modular multiplication is implemented with a 3-stage pipeline architecture. At a first stage of the pipeline, z=a·b is calculated. At a second stage of the pipeline, f+z[45:23] and 2¹³d+z[12:0] are calculated in parallel. At a third stage of the pipeline, a modular subtraction is executed to obtain the result and the result is output.

The circuit 500 as illustrated includes a non-modular multiplier 554, a register 558, a first (non-modular) adder 574, a second (non-modular) adder 578, a third (non-modular) adder 590, a fourth (modular) adder 582, a fifth (modular) adder 594, a modular subtractor 506, and a second register 510. The circuit 500 receives two variables a 550 and b 552, determines a×b mod q as a result 508, and stores the result 508 in the register 510. All modular operations are performed modulo q.

The multiplier 554 receives the variables a 550 and b 552 and generates a product 556, z[45:0]. The product 556 is stored in the register 558. Portions of the product 556 are split off and provided to adders 574, 578, and 502. Note that adder 502 is a modular adder that is part of the modular adder 594 that is customized (can be implemented using the circuit 400 of FIG. 4).

The adder 574 receives contiguous portions of the result 556 and generates a sum 567. The contiguous portions include: (i) three most significant bits 560, z[45:43], of the product 556, (ii) ten bits 562, [42:33], of the product 556, (iii) ten bits 564, [32:23], of the product 556, and (iv) ten bits 566, [22:13], of the product 556. The sum 567 is the addition of the bits 560, 562, 564, 566 and is a maximum of twelve bits.

The adder 578 receives portions of the result 556 and a portion of the sum 567 and generates a sum 580. The portions of the result 556 include: (i) the three most significant bits 560, z[45:43] and (ii) the thirteen most significant bits 570, z[45:33]. The portion of the sum 567 is the two most significant bits 586, c[11:10]. The sum 580 is a maximum of fifteen bits, f[14:0].

The adder 582 can be implemented using the circuit 300 of FIG. 3. The adder 582 receives the twenty-three most significant bits 572, z[45:23], of the result 556 and the sum 580. The adder 582 generates a modular sum 584 of the bits 572 and the sum 580 that is a maximum of twenty-three bits, e[22:0].

The adder 590 receives contiguous portions of the sum 567 and generate a sum 592, d[10:0], that is a maximum of eleven bits. The contiguous portions of the sum 567 include: (i) the two most significant bits 586, c[11:10] and (ii) the ten least significant bits 588, c[9:0].

The modular adder 594 can be implemented using the circuit 400 of FIG. 4. The modular adder 594 shifts the sum 592 left thirteen bits using a shifter 596. A shifted sum 598 is produced by the shifter 596. Thus, if d=10101010100, the shifted sum 598 is equal to 101010101000000000000000. The modular adder 502 receives the shifted sum 598 and thirteen least significant bits 568, z[12:0], of the result 556 and generates a modulo sum 504. While the shift and concatenate operation 444 is illustrated as a single unit in FIG. 4, the modular adder 594 shows the shift operator 596 separate from the concatenate operation and the concatenate operation as part of the modular adder 502.

The modular subtractor 506 receives the sum 504 and the sum 584 and generates the result 508 that is a times b modulo q. The modular subtractor 506 can be implemented using the circuit 300 of FIG. 3. The result 508 can be stored in a register 510.

Unlike Barret and Montgomery multiplication techniques, in performing modular multiplication for Dilithium cryptography (or other cryptography in which the prime number, q=8,380,417) using the circuit 500 no extra multiplications are used for modular reduction. The operations of the circuit 500 do not depend on the input data and do not leak any information. The reduction using the modulus q=8,380,417 is fast, efficient and constant-time.

The circuit 500 is a hardware-friendly reduction architecture, which can offer more efficiency when performing cryptography modulus q=8,380,417. The circuit 500 enables one to avoid using any extra multipliers (beyond a single multiplier) for modular multiplication. Keeping the number of multipliers to one in performing modular multiplication results in higher efficiency in terms of hardware resource usage and time. The circuit 500 can be optimized and mapped to field programmable gate array (FPGA) and application specific integrated circuit (ASIC) platforms, such as to develop a highly efficient PQC, Dilithium cryptography architecture.

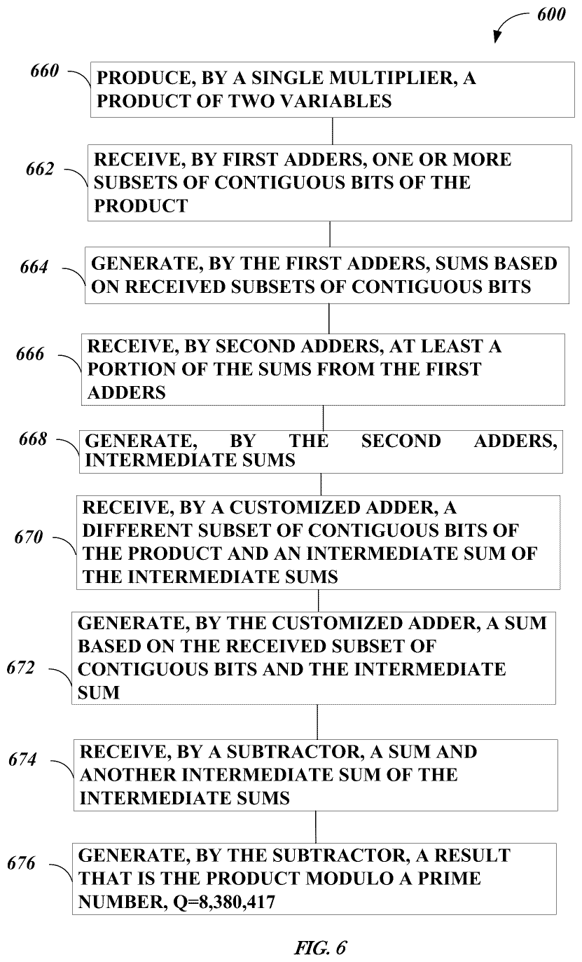

FIG. 6 illustrates, by way of example, a block diagram of an embodiment of a method 600 for modular multiplication operations. The method 600 as illustrated includes producing, by a single multiplier, a product of two variables, at operation 660; receiving, by first adders, one or more subsets of contiguous bits of the product, at operation 662; generating, by the first adders, sums based on received subsets of contiguous bits, at operation 664; receiving, by second adders, at least a portion of the sums from the first adders, at operation 666; generating, by the second adders, intermediate sums, at operation 668; receiving, by a customized adder, a different subset of contiguous bits of the product and an intermediate sum of the intermediate sums, at operation 670; generating, by the customized adder, a sum based on the received subset of contiguous bits and the intermediate sum, at operation 672; receiving, by a subtractor, a sum and another intermediate sum of the intermediate sums, at operation 674; and generating, by the subtractor, a result that is the product modulo a prime number, q=8,380,417, at operation 676.

The method 600 can further include storing, by a first register situated between the single multiplier and the first adders, the product. The first adders can be non-modular adders. The second adders can include a modular adder and a non-modular adder. The customized adder can include a modular adder. The subtractor can be a modular subtractor. The first adders can include a first adder.

The method 600 can further include receiving, as input and at the first adder, four non-overlapping subsets of contiguous bits of the product. The method 600 can further include generating, by the first adder, a sum based on the input. The first adders can further include a second adder. The method 600 can further include receiving, as input and at the second adder, two overlapping subsets of contiguous bits of the product. The method 600 can further include generating, by the second adder, a sum based on the input.

The second adders can further include a third adder. The method 600 can further include receiving, as input and at the third adder, non-overlapping subsets of contiguous bits of the sum from the first adder. The method 600 can further include generating, by the third adder, a sum based on the input.

The second adders can include a fourth adder. The method 600 can further include receiving, as input and at the fourth adder, (i) the sum from the second adder and (ii) a subset of contiguous bits of the product. The method 600 can further include generating, by the fourth adder, a sum based on the input, the sum a first intermediate result of the intermediate results.

The customized adder can further include a shifter and a fifth adder. The method 600 can further include shifting, by the shifter, the sum from the third adder a specified number of bits resulting in a shifted sum. The method 600 can further include receiving, as input and at the fifth adder, (i) the shifted sum and (ii) a subset of contiguous bits of the product. The method 600 can further include generating, by the fifth adder, a sum based on the input, the sum a second intermediate result of the intermediate results.

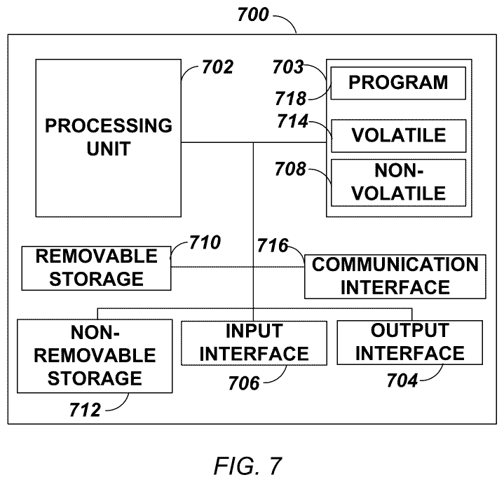

FIG. 7 illustrates, by way of example, a block diagram of an embodiment of a machine 700 (e.g., a computer system) to implement one or more embodiments. The machine 700 can implement modular multiplication. Any of the CT butterfly operator circuit 100, GS butterfly operator circuit 200, component of the circuit 300, components of the circuit 400, components of the circuit 500, method 600 or a component or operation thereof can include one or more of the components of the machine 700. One or more of the Any of the CT butterfly operator circuit 100, GS butterfly operator circuit 200, component of the circuit 300, components of the circuit 400, components of the circuit 500, method 600 or a component or operation thereof can include one or more of the components of the machine 700, or a component or operations thereof can be implemented, at least in part, using a component of the machine 700. One example machine 700 (in the form of a computer), may include a processing unit 702, memory 703, removable storage 710, and non-removable storage 712. Although the example computing device is illustrated and described as machine 700, the computing device may be in different forms in different embodiments. For example, the computing device may instead be a smartphone, a tablet, smartwatch, or other computing device including the same or similar elements as illustrated and described regarding FIG. 7. Devices such as smartphones, tablets, and smartwatches are generally collectively referred to as mobile devices. Further, although the various data storage elements are illustrated as part of the machine 700, the storage may also or alternatively include cloud-based storage accessible via a network, such as the Internet.

Memory 703 may include volatile memory 714 and non-volatile memory 708. The machine 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 700 may include or have access to a computing environment that includes input 706, output 704, and a communication connection 716. Output 704 may include a display device, such as a touchscreen, that also may serve as an input device. The input 706 may include one or more of a touchscreen, touchpad, mouse, keyboard, camera, one or more device-specific buttons, one or more sensors integrated within or coupled via wired or wireless data connections to the machine 700, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 702 (sometimes called processing circuitry) of the machine 700. A hard drive, CD-ROM, and RAM are some examples of articles including a non-transitory computer-readable medium such as a storage device. For example, a computer program 718 may be used to cause processing unit 702 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a modular multiplication circuit comprising a single multiplier configured to receive two variables and produce a product of the two variables, first adders configured to receive one or more subsets of contiguous bits of the product and generate sums based on received subsets of contiguous bits, second adders configured to receive at least a portion of the sums from the first adders and generate intermediate sums, a customized adder configured to receive another, different subset of contiguous bits of the product and an intermediate sum of the intermediate sums and generate a sum based on the received subset of contiguous bits and the intermediate sum, and a subtractor configured to receive the sum from the customized adder and another intermediate result of the intermediate results and generate a result that is the product modulo a prime number, q=8,380,417.

In Example 2, Example 1 further includes a first register situated between the single multiplier and the first adders.

In Example 3, at least one of Examples 1-2 further includes, wherein the first adders are non-modular adders, the second adders include a modular adder and a non-modular adders, the customized adder is a modular adder, and the subtractor is a modular subtractor.

In Example 4, Example 3 further includes, wherein the first adders include a first adder configured to receive, as input, four non-overlapping subsets of contiguous bits of the product and generate a sum based on the input.

In Example 5, Example 4 further includes a second adder configured to receive, as input, two overlapping subsets of contiguous bits of the product and generate a sum based on the input.

In Example 6, Example 5 further includes, wherein the second adders include a third adder configured to receive, as input, non-overlapping subsets of contiguous bits of the sum from the first adder and generate a sum based on the input.

In Example 7, Example 6 further includes, wherein the second adders further include a fourth adder configured to receive, as input, (i) the sum from the second adder and (ii) a subset of contiguous bits of the product and generate a sum based on the input, the sum a first intermediate result of the intermediate results.

In Example 8, Example 7 further includes, wherein the customized adder includes a shifter configured to shift the sum from the third adder a specified number of bits resulting in a shifted sum, and a fifth adder configured to receive, as input, (i) the shifted sum and (ii) a subset of contiguous bits of the product and generate a sum based on the input, the sum a second intermediate result of the intermediate results.

Example 9 includes a method for modular multiplication comprising producing, by a single multiplier, a product of two variables, receiving, by first adders, one or more subsets of contiguous bits of the product, generating, by the first adders, sums based on received subsets of contiguous bits, receiving, by second adders, at least a portion of the sums from the first adders, generating, by the second adders, intermediate sums, receiving, by a customized adder, a different subset of contiguous bits of the product and an intermediate sum of the intermediate sums, generating, by the customized adder, a sum based on the received subset of contiguous bits and the intermediate sum, receiving, by a subtractor, a sum and another intermediate sum of the intermediate sums, and generating, by the subtractor, a result that is the product modulo a prime number, q=8,380,417.

In Example 10, Example 9 further includes, storing, by a first register situated between the single multiplier and the first adders, the product.

In Example 11, at least one of Examples 9-10 further includes, wherein the first adders are non-modular adders, the second adders include a modular adder and a non-modular adder, the customized adder includes a modular adder, and the subtractor is a modular subtractor.

In Example 12, Example 11 further includes, wherein the first adders include a first adder and the method further comprises receiving, as input and at the first adder, four non-overlapping subsets of contiguous bits of the product, and generating, by the first adder, a sum based on the input.

In Example 13, Example 12 further includes, wherein the first adders further include a second adder and the method further comprises receiving, as input and at the second adder, two overlapping subsets of contiguous bits of the product, and generating, by the second adder, a sum based on the input.

In Example 14, Example 13 further includes, wherein the second adders further include a third adder and the method further comprises receiving, as input and at the third adder, non-overlapping subsets of contiguous bits of the sum from the first adder, and generating, by the third adder, a sum based on the input.

In Example 15, Example 14 further includes, wherein the second adders include a fourth adder and the method further comprises receiving, as input and at the fourth adder, (i) the sum from the second adder and (ii) a subset of contiguous bits of the product, and generating, by the fourth adder, a sum based on the input, the sum a first intermediate result of the intermediate results.

In Example 16, Example 15 further includes, wherein the customized adder further includes a shifter and a fifth adder and the method further comprises shifting, by the shifter, the sum from the third adder a specified number of bits resulting in a shifted sum, receiving, as input and at the fifth adder, (i) the shifted sum and (ii) a subset of contiguous bits of the product, and generating, by the fifth adder, a sum based on the input, the sum a second intermediate result of the intermediate results.

Example 17 includes a butterfly operator circuit comprising a modular multiplication circuit comprising a single multiplier configured to receive two variables and produce a product of the two variables, and adders and a subtractor configured to receive one or more subsets of contiguous bits of the product and generate sums based on received subsets of contiguous bits an adder configured to receive intermediate sums and generate a result that is the product modulo a prime number, q=8,380,417, a modular adder circuit configured to (a) receive (i) the product and (ii) a third variable as input and generate a sum as output or (b) receive two other variables as input and generate a different sum as output, and a modular subtractor circuit configured to (a) receive the result and the third variable as input and generate a difference as output or (b) receive the two other variables as input and generate a different difference as output, the different difference one of the two variables.

In Example 18, Example 17 further includes a first register situated between the single multiplier and the adders.

In Example 19, at least one of Examples 17-18 further includes, wherein the adders include non-modular adders and modular adders.

In Example 20, Example 19 further includes, wherein the adders include three non-modular adders and two modular adders and the subtractor is a modular subtractor.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A modular multiplication circuit comprising:
a single multiplier configured to receive two variables and produce a product of the two variables;
first adders configured to receive one or more subsets of contiguous bits of the product and generate sums based on received subsets of contiguous bits;
second adders configured to receive at least a portion of the sums from the first adders and generate intermediate sums;
a customized adder configured to receive another, different subset of contiguous bits of the product and an intermediate sum of the intermediate sums and generate a sum based on the received subset of contiguous bits and the intermediate sum; and
a subtractor configured to receive the sum from the customized adder and another intermediate result of the intermediate results and generate a result that is the product modulo a prime number, q=8,380,417.

2. The circuit of claim 1, further comprising a first register situated between the single multiplier and the first adders.

3. The circuit of claim 1, wherein the first adders are non-modular adders, the second adders include a modular adder and a non-modular adder, the customized adder is a modular adder, and the subtractor is a modular subtractor.

4. The circuit of claim 3, wherein the first adders include:
a first adder configured to receive, as input, four non-overlapping subsets of contiguous bits of the product and generate a sum based on the input.

5. The circuit of claim 4, wherein the first adders further include:
a second adder configured to receive, as input, two overlapping subsets of contiguous bits of the product and generate a sum based on the input.

6. The circuit of claim 5, wherein the second adders include:
a third adder configured to receive, as input, non-overlapping subsets of contiguous bits of the sum from the first adder and generate a sum based on the input.

7. The circuit of claim 6, wherein the second adders further include:
a fourth adder configured to receive, as input, (i) the sum from the second adder and (ii) a subset of contiguous bits of the product and generate a sum based on the input, the sum a first intermediate result of the intermediate results.

8. The circuit of claim 7, wherein the customized adder includes:
a shifter configured to shift the sum from the third adder a specified number of bits resulting in a shifted sum; and
a fifth adder configured to receive, as input, (i) the shifted sum and (ii) a subset of contiguous bits of the product and generate a sum based on the input, the sum a second intermediate result of the intermediate results.

9. A method for modular multiplication comprising:
producing, by a single multiplier, a product of two variables;
receiving, by first adders, one or more subsets of contiguous bits of the product;
generating, by the first adders, sums based on received subsets of contiguous bits;
receiving, by second adders, at least a portion of the sums from the first adders;
generating, by the second adders, intermediate sums;
receiving, by a customized adder, a different subset of contiguous bits of the product and an intermediate sum of the intermediate sums;
generating, by the customized adder, a sum based on the received subset of contiguous bits and the intermediate sum;
receiving, by a subtractor, a sum and another intermediate sum of the intermediate sums; and
generating, by the subtractor, a result that is the product modulo a prime number, q=8,380,417.

10. The method of claim 9, storing, by a first register situated between the single multiplier and the first adders, the product.

11. The method of claim 9, wherein the first adders are non-modular adders, the second adders include a modular adder and a non-modular adder, the customized adder includes a modular adder, and the subtractor is a modular subtractor.

12. The method of claim 11, wherein the first adders include a first adder and the method further comprises:
receiving, as input and at the first adder, four non-overlapping subsets of contiguous bits of the product; and
generating, by the first adder, a sum based on the input.

13. The method of claim 12, wherein the first adders further include a second adder and the method further comprises:
receiving, as input and at the second adder, two overlapping subsets of contiguous bits of the product; and
generating, by the second adder, a sum based on the input.

14. The method of claim 13, wherein the second adders further include a third adder and the method further comprises:
receiving, as input and at the third adder, non-overlapping subsets of contiguous bits of the sum from the first adder; and
generating, by the third adder, a sum based on the input.

15. The method of claim 14, wherein the second adders include a fourth adder and the method further comprises:
receiving, as input and at the fourth adder, (i) the sum from the second adder and (ii) a subset of contiguous bits of the product; and
generating, by the fourth adder, a sum based on the input, the sum a first intermediate result of the intermediate results.

16. The method of claim 15, wherein the customized adder further includes a shifter and a fifth adder and the method further comprises:
shifting, by the shifter, the sum from the third adder a specified number of bits resulting in a shifted sum;
receiving, as input and at the fifth adder, (i) the shifted sum and (ii) a subset of contiguous bits of the product; and
generating, by the fifth adder, a sum based on the input, the sum a second intermediate result of the intermediate results.

17. A butterfly operator circuit comprising:
a modular multiplication circuit comprising:
a single multiplier configured to receive two variables and produce a product of the two variables; and
adders and a subtractor configured to receive one or more subsets of contiguous bits of the product and generate sums based on received subsets of contiguous bits an adder configured to receive intermediate sums and generate a result that is the product modulo a prime number, q=8,380,417;
a modular adder circuit configured to (a) receive (i) the product and (ii) a third variable as input and generate a sum as output or (b) receive two other variables as input and generate a different sum as output; and
a modular subtractor circuit configured to (a) receive the result and the third variable as input and generate a difference as output or (b) receive the two other variables as input and generate a different difference as output, the different difference one of the two variables.

18. The circuit of claim 17, further comprising a first register situated between the single multiplier and the adders.

19. The circuit of claim 17, wherein the adders include non-modular adders and modular adders.

20. The circuit of claim 19, wherein the adders include three non-modular adders and two modular adders and the subtractor is a modular subtractor.
